(19) United States
(12) Patent Application Publication
(10) Pub. No.: US 2002/0103879 A1
(43) Pub. Date: Aug. 1, 2002

(54) Method of advertising via the internet

(76) Inventor: Oscar A. Mondragon, Toluca (MX)

Correspondence Address: BIRCH STEWART KOLASCH & BIRCH, PO BOX 747, FALLS CHURCH, VA, 22040-0747, US

(21) Appl. No.: 09/769,514

(22) Filed: Jan. 26, 2001

(51) Int. Cl. G06F 15/16

(52) U.S. Cl. 709/218; 709/204

(57) ABSTRACT

A method for advertising the products and services of companies via the internet by having the companies sponsor service free of charge to users of the internet. The user may access the web page of a service provider, where said user is and sponsors. Once the user has chosen the desired combination of application/free service/sponsor, the application selected by the user takes on the look and feel of the selected sponsor. In exchanges for using the sponsor's service free of charge, the user also accepts to receive advertisement(s) from the sponsor while using the internet sponsored applications by means of banners, surveys, etc.

### BACKGROUND OF THE INVENTION

1. Technical Field of the Invention

This invention generally relates to applications and features related to internet advertising. More particularly, the present invention is directed to a method of advertising on the internet where users of the internet are provided services and/or applications free of charge in return for accepting a condition to receive advertisements from those entities providing the free services and/or applications.

2. Description of Related Art

Internet users frequently require additional hard disk storage space to store files, e-mail messages, backups of other files, etc. Currently, several internet service providers (ISPs) offer users data storage space in a hard disk that is located at the ISP server. For example, ISPs such as YAHOO and HOT-MAIL offer a free e-mail service with about 5 MBytes of storage space in the ISP hard disk server, in an effort to increase the numbers of potential users (traffic) visiting their respective web pages or web sites. The cost to the ISP of providing this storage for users is offset by those advertisers whose publicity and advertisements appear on the ISP's web page or web site, typically in the form of a banner. However, the data storage space is often limited to a fixed amount of megabytes (i.e., 5 MB), that is provided by the ISP, without the possibility of the user being able to get an increase in storage space.

Other service providers such as IDRIVE.COM and XDRIVE.COM, offer data storage space in a hard disk that is located at the service provider (e.g., a virtual hard disk). These service providers provide the user a free storage space that is limited in that the user is billed based on the excess megabytes actually being used by the user. Further, ISPs such as AOL and TERRA LIBRE offer users free access to the internet, but limit the free access to a period of time, in order to allow the user to familiarize his or herself with the services and/or applications offered on the corresponding web page of the ISP. After the limited period expires, the user is charged for further use.

However, none of the above ISPs offer certain services or applications, such as the aforementioned free storage space to a user in return for a condition that the user accept a condition set by the provider of such free service or application. Thus what is needed is a way to offer certain services free of charge and for an unlimited time, to an internet user in return for the user accepting advertising generated by the provider or the free service/application.

### SUMMARY OF THE INVENTION

The present invention is directed to a method for advertising through the internet that overcomes the limitations imposed by the ISPs set forth above. In an aspect, the products and services of companies are advertised by the companies sponsoring services and/or application such as hard disk space, access time or other value added services over the internet, free of charge to the user. The limitations imposed by the ISPs above may be removed by providing a method, which may be embodied on the internet, whereby companies sponsor the applications and/or services that are frequently used on the internet.

The value added services are sponsored in exchange for the user accepting a condition to receive advertisement from the sponsor on its products and/or services. The advertisement itself may have the look and feel of the web interfaces by which the user gains access to internet services and/or tools related to those value-added services sponsored by the company. For example, the advertisement may be in the form of banners, e-mail, calendar or other message types; surveys or questionnaires, or any other type of communication menas accessible to the user via the internet.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exemplary flow diagram illustrating the method in accordance with the present invention.

### DETAILED DESCRIPTION

The method according to the invention includes enabling an internet user to have access to a web page through an internet service provider (ISP) for example, in which a number of free internet applications are sponsored (offered) by companies, preferably in menu format, to the user. In an embodiment, some typical applications offered to the user might be e-mail, calendar, directory, ICQ, instant messaging, chat rooms, or any other application commonly used in the Internet. The web page accessed by the user also provides information of services free of charge that are available in the ISP's server. In an embodiment, some services free of charge that may be offered to the user include data storage space in the server hard disk, access time to the Internet, or any other service of continuous and/or frequent use on the internet.

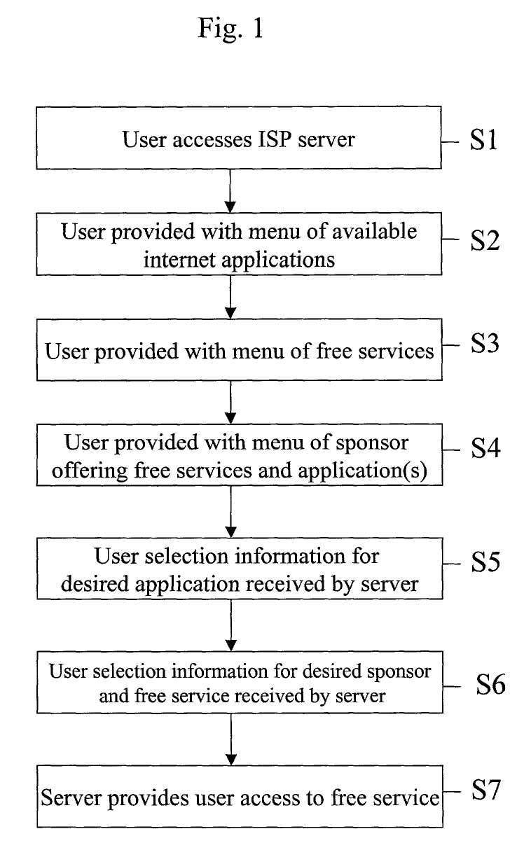

FIG. 1 is an exemplary flow diagram illustrating the method in accordance with the present invention. Referring to FIG. 1, a user is providing with access to an ISP server on the internet (step S1). This can be done using well-known interfaces (dial-up, ISDN, cable modem, etc.). Once a user has access to the web site of the ISP, he/she is provided with a menu screen of internet applications available on the server (Step S2). Additionally, the user is provided with a menu of services that are free of charge (Step S3) along with a menu listing of those companies or businesses that are the sponsors (Step S4) of the aforementioned free services in exchange for an agreement to use their applications, products, services, etc.

With the multiple menu display in front of the user, the user then indicates or selects the desired application to use through the ISP via a suitable graphical user interface (mouse, keyboard, etc.), which is received by the server (Step S5); and also selects the desired sponsor to use for the free service, which is received by the server (Step S6). Thereafter, the server provides the user access to the selected free service (Step S7), with the corresponding application of the sponsor agreed upon by the user in return for the free service taking on the look and feel of the selected sponsor, as to be described further below.

As previously noted, the user may also be provided with a menu of sponsors of the different services that are free of charge and available to the user. Thus, an internet user may access the web page of the service provider, which informs the user of the available combinations of companies who are interested in sponsoring certain internet services free of charge, in exchange of the user accepting conditions such as are described below. For example, the user may find combinations such as:

(a) Sponsor A offers 10 MB in hard disk space If user accepts to use the calendar offered by Sponsor A;

(b) Sponsor B offers 25 MB in hard disk space if user accepts to use the e-mail service of Sponsor B;

(c) Sponsor C offers 50 MB in hard disk space if user accepts to use both a calendar and an e-mail service of Sponsor C. The user chooses the combination that fits his/her needs and in doing so, the user sends information that is received by the service provider. The information received by the user establishes a group of attributes and privileges to which the user will be assigned, from a plurality of predetermined groups of attributes and privileges residing at the service provider's server.

Once the user has been assigned to one of the plurality of groups of attributes and privileges, the application selected by the user takes on the look and feel, also known as the “skin”, of the selected sponsor of the service, free of charge. In other words, every time the user enters the selected application, the skin of the sponsor is displayed on the user's screen or display. The skin of the sponsor may include the logo, icon(s), trademark, combination of colors, etc. associated with the sponsor; of course said group of attributes does not interfere with the performance of the application. Simultaneously with the assignment of the particular group of attributes and privileges, the user is provided with access to the selected service free of charge.

Additionally, it is also contemplated that the user may receive, permanently or intermittently, banners with information of the products or services of the chosen sponsor. In an alternative embodiment, before allowing the user to use the services free of charge, it is possible to request the user to provide personal information such as name, address, country, e-mail address, etc. The information provided by the user can then be used to maintain a database useful to conduct surveys, for conducting segmented marketing, etc.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

What is claimed is:

1. A method for advertising through the Internet, comprising:
(a) providing a user with access to a service provider server through the internet;
(b) providing said user a menu of internet applications available on the server;
(c) providing said user a menu of free services that are available on the server;
(d) providing said user a menu of sponsors of the said free services on the server;
(e) receiving information from the user on a selected internet application that said user desires to use;
(f) receiving information from the user on a selected sponsor that offers a free service that is available on the server; and
(g) providing said user with access to use said free service of said selected sponsor,
wherein said internet application selected by said user takes on a look and feel of the selected sponsor of the free service.

2. The method of claim 1, wherein said free service is a predetermined amount of data storage space in a hard disk of the service provider server.

3. The method of claim 1, wherein said free service is access time to the internet.

4. The method of claim 1, wherein said application includes at least one application selected from the group comprising e-mail, calendars, instant messaging applications and chat rooms.

5. The method of claim 1 wherein step (e) further includes receiving to said selection information.

6. The method of claim 5, wherein the personal information provided by said include the name, address, country and e-mail address of said user

7. The method of claim 5, wherein said personal information provided by the user is maintained in a database.

8. The method of claim 7, wherein said personal information provided by said user is used for conducting surveys, for conducting segmented marketing or for sending banner to selected users.
